(19) United States
(12) Patent Application Publication
(10) Pub. No.: US 2004/0146165 A1
(43) Pub. Date: Jul. 29, 2004

(54) Digital music broadcasting audio system

(75) Inventor: Stephen Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/353,046

(22) Filed: Jan. 29, 2003

(51) Int. Cl. H04H 5/00; G06F 17/00

(52) U.S. Cl. 381/2; 700/94

(57) ABSTRACT

A digital music broadcasting audio system and particularly a music broadcasting audio system to retrieve digital music information from different storage devices consists of a basic audio system structure (including at least a tape broadcasting device, a CD broadcasting device, a radio-receiving device, a front end processor, an audio selection switch, a back end amplifier and one or more speaker) to couple with a storage device input unit so that users can retrieve digital music information from different storage devices, and the audio system can broadcast digital music besides performing the function of broadcasting radio, CDs and cartridge tapes.

### BACKGROUND OF THE INVENTION

1. Field of the Invention

The invention relates to a digital music broadcasting audio system and particularly a music broadcasting audio system that allows users to retrieve digital music information from different storage devices and retrieves and broadcasts digital music in addition to performing the function of broadcasting and playing the CD or cartridge tape.

2. Description of the Prior Art

The basic structure of a general audio system 1 (as shown in FIG. 1) mainly consists of a tape broadcasting device 11, a CD broadcasting device 12, a radio receiving device 13, a front end processor 14, an audio selection switch 15, a back end amplifier 16 and one or more speaker 17. Except to provide basic broadcasting of the CD, tape and radio, it cannot broadcast digital music.

Refer to FIG. 2 for the basic structure of a present digital personal music player 2 (MP3). It mainly includes a memory unit 21, a digital music broadcasting unit 22, an earphone jack 23 and an earphone 24. The memory unit 21 contains recording digital music information. The memory unit 21 may be a flash memory or a memory card. As the capacity of the memory unit 21 is limited, users have to update (or replace) the memory unit 21 (memory card) frequently. It is not convenient to use. Presently, there are portable data storage devices that have huge data storage capacities. They are mostly made in the form of a portable disk with USB as the interface. Their capacities may be up to one billion bytes (1GB). The USB interface is universally adaptable to various types of information products. Hence if the memory unit 21 of the conventional digital personal music player 2 is adopted the portable disk of USB interface, the performance of the digital personal music player 2 can be greatly enhanced, and users can be freed from the trouble of updating data frequently.

### SUMMARY OF THE INVENTION

In view of the aforesaid disadvantages such as the general audio system cannot broadcast digital music, the digital personal music player has a limited memory capacity and cannot broadcast music as the ordinary audio system does to enable more than one people to listen concurrently, the invention aims at providing a novel audio system that mainly includes a basic audio system structure (including at least a tape broadcasting device, a CD broadcasting device, a radio receiving device, a front end processor, an audio selection switch, a back end amplifier and one or more speaker) to couple with a storage device input unit so that users can retrieve digital music information from different storage devices, and the audio system can broadcast digital music besides performing the function of broadcasting radio, CD and cartridge tape.

The primary object of the invention is to provide a digital music broadcasting audio system and particularly a music broadcasting audio system that allows users to retrieve music information from different storage devices, and performs functions of broadcasting and playing CD and cartridge tape, and retrieves and broadcasts digital music.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic block diagram of the basic structure of a conventional audio system.

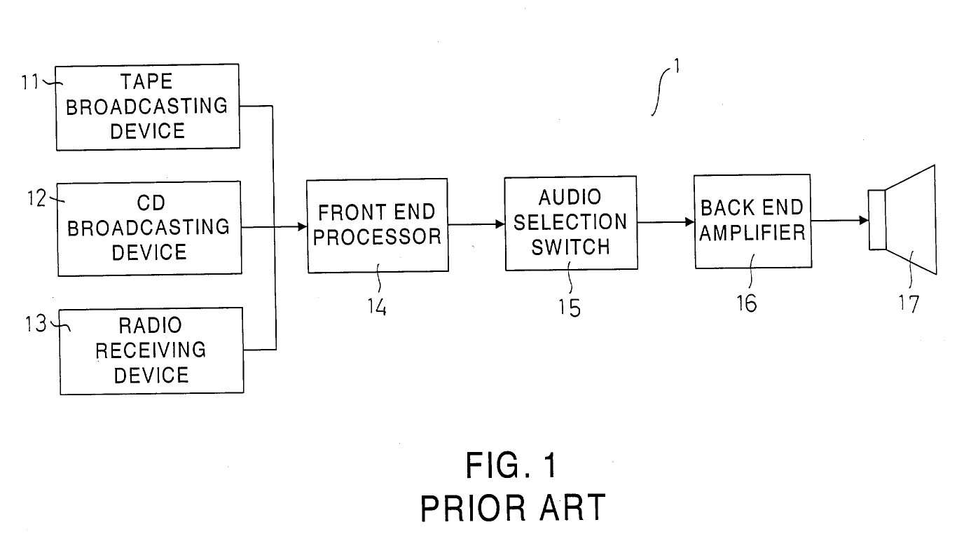

FIG. 2 is a block diagram of the basic structure of a conventional digital personal music player.

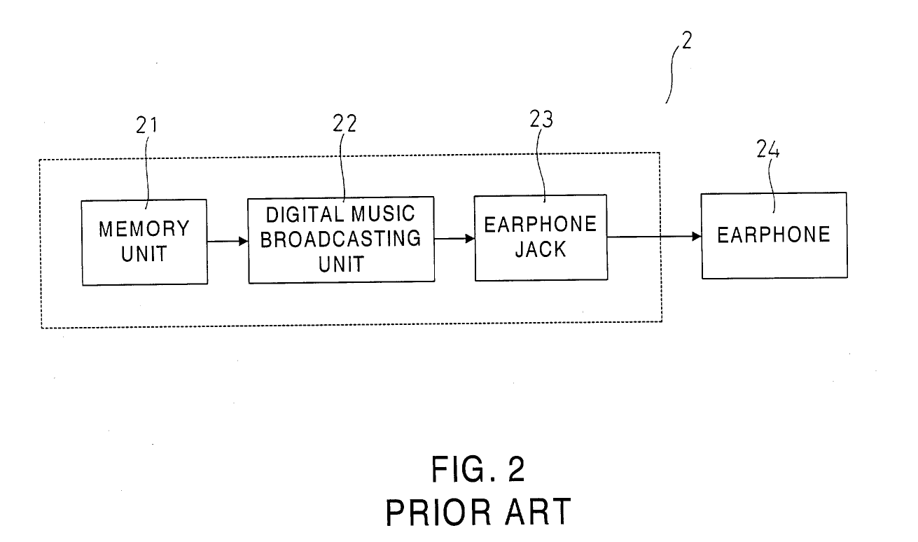

FIG. 3 is a schematic block diagram of an embodiment of the digital music broadcasting audio system of the invention.

FIG. 4 is a schematic block diagram of the storage device and input unit of the invention.

### DESCRIPTION OF THE PREFERRED EMBODIMENT

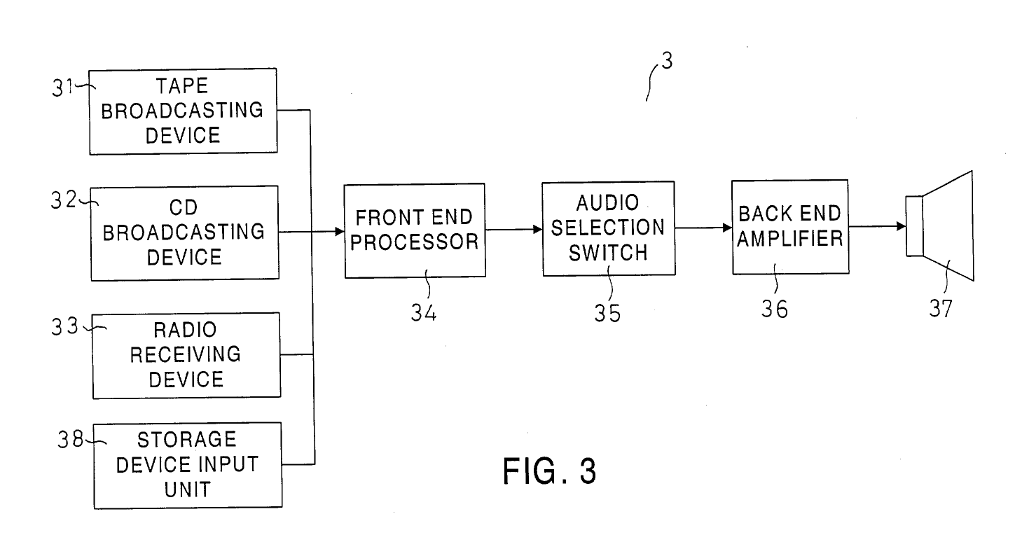

Referring to FIG. 3, the digital music broadcasting audio system 3 of the invention mainly includes a basic audio broadcasting structure (including at least a tape broadcasting device 31, a CD broadcasting device 32, a radio receiving device 33, a front end processor 34, an audio selection switch 35, a back end amplifier 36 and one or more speaker 37) to couple with a storage device input unit 38; wherein:

the tape broadcasting device 31 is to hold and broadcast a cartridge tape;

the CD broadcasting device 32 is to hold and broadcast a CD;

the radio receiving device 33 is to receive radio broadcasting channels;

the front end processor 34 is to process audio signals including gain, eliminating noises or the like;

the audio selection switch 35 is to switch the sources of audio output;

the back end amplifier 36 is to output audio gain; and

the speaker 37 is to generate audio output.

(the foregoing basic audio broadcasting structure is adopted in general audio systems and forms no part of the invention, thus only a brief description is provided).

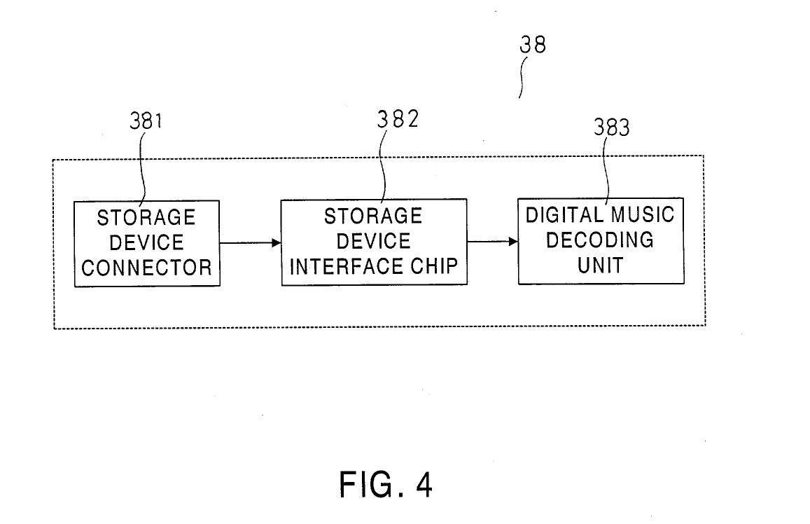

The feature of the invention is the storage device input unit 38 (as shown in FIG. 4) which includes:

a storage device connector 381 for connecting to the storage device, such as a memory card slot, a USB connector, etc. The storage device may be a portable disk or a memory card with a USB interface (such as CF, MD, SD, MMC, SM, MS, etc.).

a storage device interface chip 382 for retrieving the information stored in the storage device; and

a digital music decoding unit 383 for transforming the digital music information in the storage device to music signals for broadcasting.

By means of the construction set forth above, users may plug the digital storage device in the storage device connector 381 of the digital music broadcasting audio system 3 of the invention, and through the storage device interface chip 382 to read the digital music information stored in the digital storage device and transfer to the digital music decoding unit 383. The digital music decoding unit 383 decodes the information and transfers to the front end processor 34, then through the audio selection switch 35, the back end amplifier 36, and the speaker 37 to broadcast digital music.

In summary, the invention can retrieve digital music information from different storage devices and broadcast the digital music.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A digital music broadcasting audio system comprising a basic audio system structure and a storage device input unit, wherein the storage device input unit includes:
a storage device connector for connecting to a storage device;
a storage device interface chip for retrieving information stored in the storage device; and
a digital music decoding unit for transforming digital music information stored in the storage device to music signals for broadcasting;
wherein the digital music broadcasting audio system broadcasts FM and AM radio music and cartridge tapes, and the storage device is formed in various fashions to contain the digital music information which are retrievable by users for broadcasting.

2. The digital music broadcasting audio system of claim 1 further including at least a tape broadcasting device, a CD broadcasting device, a radio receiving device, a front end processor, an audio selection switch, a back end amplifier and one or more speaker.

3. The digital music broadcasting audio system of claim 1, wherein the storage device connector is a memory card inserting slot.

4. The digital music broadcasting audio system of claim 1, wherein the storage device connector is a USB connector.
